(19) United States
(12) Patent Application Publication
(10) Pub. No.: US 2025/0334939 A1
(43) Pub. Date: Oct. 30, 2025

(54) METHODS AND SYSTEMS FOR CORROSION PREDICTION USING MACHINE LEARNING

(71) Applicant: SAUDI ARABIAN OIL COMPANY, Dhahran (SA)

(72) Inventors: Rayed Zayer, Tarout (SA); Mohammad Al Kadem, Qatif (SA); Ali Aithan, Umran (SA); Mohammed Al Nasr, Qatif (SA)

(73) Assignee: SAUDI ARABIAN OIL COMPANY, Dhahran (SA)

(21) Appl. No.: 18/649,627

(22) Filed: Apr. 29, 2024

(51) Int. Cl. G05B 13/04; G05B 13/02; G05B 23/02

(52) U.S. Cl. CPC G05B 13/042; G05B 13/027; G05B 13/048; G05B 23/0275

(57) ABSTRACT

Methods and systems relating to determining corrosion of a well or pipe of the well using machine learning. The methods and systems include obtaining well data from the well, obtaining a set of operation parameters that control operation of the well, and determining with a set of machine learning models a set of corrosion metrics based on the well data. Each corrosion metric in the set of corrosion metrics is indicative of corrosion at a location of the well. The methods and systems further include forming an aggregate corrosion prediction from the set of corrosion metrics and adjusting, with a controller, the set of operation parameters based on, at least, the aggregate corrosion prediction.

### BACKGROUND

In the oil and gas industry, corrosion continually affects the production tubing, casings, and pipelines associated with wells. The corrosion stems from chemical, electrochemical, and mechanical processes and requires costly repair and maintenance operations to prevent loss of produced hydrocarbons. If left unchecked, corrosion may result in the abandonment of a well or the unscheduled shutdown of a well and/or gas processing plants. Additional upstream and downstream activities can be affected, directly or indirectly, by corrosion.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a method including obtaining well data from a well, obtaining a set of operation parameters that control operation of the well, and determining, with a set of machine learning models including a first machine learning model, a set of corrosion metrics based on the well data. Each corrosion metric in the set of corrosion metrics is indicative of corrosion at a location of the well. The method further includes forming an aggregate corrosion prediction from the set of corrosion metrics and adjusting, with a controller, the set of operation parameters based on, at least, the aggregate corrosion prediction.

Embodiments disclosed herein generally relate to a system including a well, a network model comprising a simulator and an optimizer, and a controller. The controller can configure one or more configurable parameters of the well. The one or more configurable parameters are included in a set of operation parameters. The controller is configured to obtain well data from the well and determine, with a set of machine learning models including a first machine learning model, a set of corrosion metrics based on the well data. Each corrosion metric in the set of corrosion metrics is indicative of corrosion at a location of the well. The controller is further configured to form an aggregate corrosion prediction from the set of corrosion metrics and adjust the set of operation parameters based on, at least, the aggregate corrosion prediction.

Embodiments disclosed herein generally relate to a non-transitory computer-readable memory with computer-executable instructions stored thereon that, when executed on a processor, cause the processor to perform one or more steps. The steps include obtaining well data from a well and obtaining a set of operation parameters that control operation of the well. The steps further include determining, with a set of machine learning models including a first machine learning model, a set of corrosion metrics based on the well data. Each corrosion metric in the set of corrosion metrics is indicative of corrosion at a location of the well. The steps further include forming an aggregate corrosion prediction from the set of corrosion metrics and adjusting, with a controller, the set of operation parameters based on, at least, the aggregate corrosion prediction.

Other aspects and advantages of the claimed subject matter will be apparent from the following description and the appended claims.

### BRIEF DESCRIPTION OF DRAWINGS

Specific embodiments disclosed herein will now be described in detail with reference to the accompanying figures. Like elements in the various figures are denoted by like reference numerals for consistency. Like elements may not be labeled in all figures for the sake of simplicity.

FIG. 1A depicts the drilling of a wellbore in accordance with one or more embodiments.

FIG. 1B depicts a pipeline in accordance with one or more embodiments.

FIG. 2 depicts a cased wellbore in accordance with one or more embodiments.

FIG. 3 depicts a process using a set of machine learning models in accordance with one or more embodiments.

FIG. 4 depicts a system in accordance with one or more embodiments.

FIG. 5 depicts a flowchart in accordance with one or more embodiments.

FIG. 6 depicts a neural network in accordance with one or more embodiments.

FIG. 7 depicts a flowchart in accordance with one or more embodiments.

FIG. 8 depicts a computing system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “historical log” includes reference to one or more of such logs.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

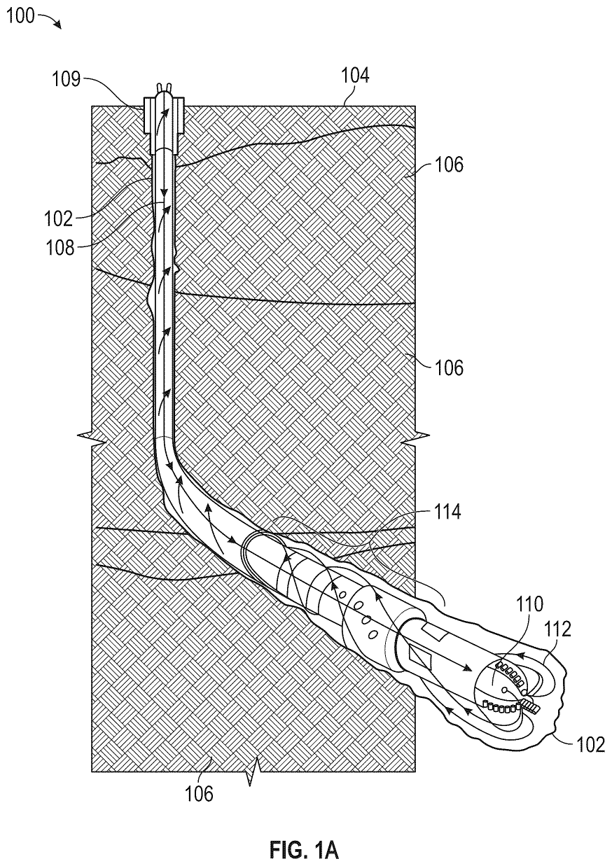

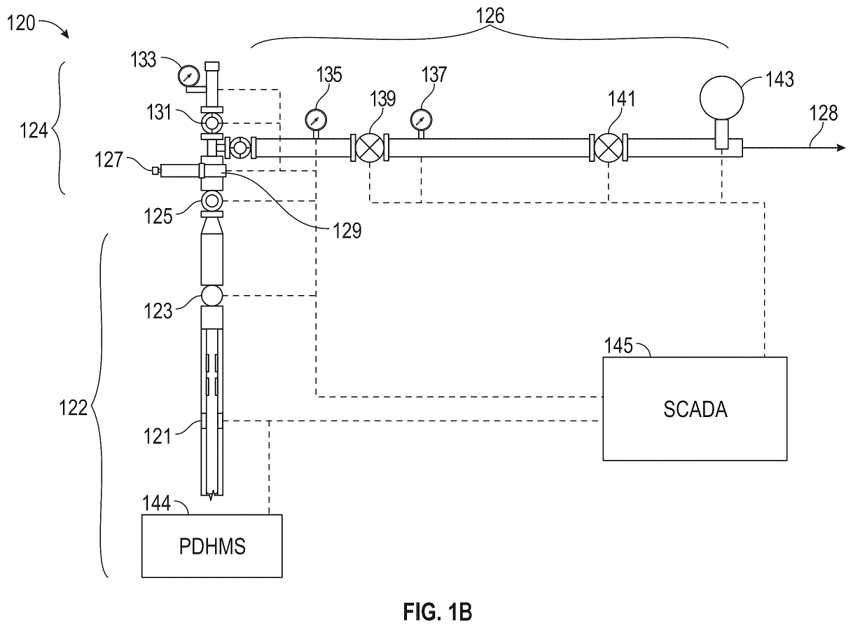

A general overview of the subsurface activities associated with a drilling process are provided in FIG. 1A. For brevity, above surface equipment, or other offshore rig platform and equipment, used in a drilling operation are not depicted as well sites may be configured in many ways. However, exclusion of well site configurations should not be considered limiting as the tools and methods described herein are invariant to well site configurations. As seen, a drilling operation at a well site may include drilling a wellbore (102) into a subsurface region (106) including various formations to access one or more sources of hydrocarbons (i.e., reservoirs). To drill a new section of wellbore (102), typically, a drill bit (110) with drilling fluid nozzle is connected to the down-hole end of a drill string (108), which is a series of drill pipes connected to form a conduit, that is rotated from the surface (104) while pushing the drill bit (110) against the rock forming a wellbore (102) in the ground and through the subsurface (106). In some implementations, the drill bit (110) may be rotated by a combined effect of surface rotation and with a down-hole drilling motor (not shown).

While cutting rock with a drill bit (110), typically, a drilling fluid (112) is circulated (with a pump) through the drill string (108), out of the drilling fluid nozzle of the drill bit (110), and back to the surface (104) through the substantially annular space between the wellbore (102) and the drill string (108). Moreover, the drill string (108) may contain a bottom hole assembly (BHA) (114) disposed at the distal end, or down-hole portion, of the conduit. To guide the drill bit (110), monitor the drilling process, and collect data about the subsurface (106) formations, among other objectives, the BHA (114) of the drill string (108) may be outfitted with “logging-while-drilling” (LWD) tools, “measurement-while-drilling-tools” (MWD), and a telemetry module. An MWD or LWD tool is generally a sensor, or measuring device, which collects information in an associated log during the drilling process. The measurements and/or logs may be transmitted to the surface (104) using any suitable telemetry system known in the art. The BHA (114) and the drill string (108) may contain other drilling tools known in the art but not specifically stated. By means of example, common logs, or information collected by LWD tools, may include, but are not limited to, the density of the subsurface (106) formation, the effective porosity of the subsurface (106) formation, and temperature.

Depending on the depth of a hydrocarbon bearing formation and other geological complexes, a well can have several hole sizes before it reaches its target depth. A steel pipe, or casing (109), may be lowered in each hole and a cement slurry may be pumped from the bottom up through the substantially annular space between the casing (109) and the wellbore (102) to fix the casing (109), and seal the wellbore (102) from the surrounding subsurface (106) formations. Upon finishing drilling the wellbore (102), the well may undergo a completions process to facilitate accessibility to the well and access the desired hydrocarbons. In some implementations, the final wellbore (102) can be completed using either cased and cemented pipe, which is later perforated to access the hydrocarbon, or it may be completed using a multi-stage open-hole packers assembly. Further, production tubing may be used to transport hydrocarbons from one or more reservoirs in the subsurface (106) formations to the surface (104).

In accordance with one or more embodiments, FIG. 1B depicts a simplified portion of a pipeline (120) of a multilateral well in an oil and gas field. Herein, an oil and gas field is broadly defined to consist of wells which produce at least some oil and/or gas. Hydrocarbon wells typically produce oil, gas, and water in combination. The relative amounts of oil, gas, and water may differ between wells and vary over any one well's lifetime.

For clarity, the pipeline (120) is divided into three sections; namely, a subsurface (122) section, a tree (124) section, and a flowline (126) section. It is emphasized that pipelines (120) and other components of wells and, more generally, oil and gas fields may be configured in a variety of ways. As such, one with ordinary skill in the art will appreciate that the simplified view of FIG. 1B does not impose a limitation on the scope of the present disclosure. As part of the subsurface (122) section, FIG. 1B shows an inflow control valve (ICV) (121). An ICV (121) is an active component usually installed during well completion. The ICV (121) may partially or completely choke flow into a well. Generally, multiple ICVs (121) are installed along the reservoir section of a wellbore. Each ICV (121) is separated from the next by a packer. Each ICV (121) can be adjusted and controlled to alter flow within the well and, as the reservoir depletes, prevent unwanted fluids from entering the wellbore. The subsurface (122) section of the pipeline (120) has a subsurface safety valve (SSSV) (123). The SSSV (123) is designed to close and completely stop flow in the event of an emergency. Generally, an SSSV (123) is designed to close on failure. That is, the SSSV (123) requires a signal to stay open and loss of the signal results in the closing of the valve. Also shown as part of the subsurface (122) section is a permanent downhole monitoring system (PDHMS) (144). The PDHMS (144) consists of a plurality of sensors, gauges, and controllers to monitor subsurface flowing and shut-in pressures and temperatures. As such, a PDHMS (144) may indicate, in real-time, the state or operating condition of subsurface equipment and the fluid flow.

Turning to the tree (124) section of FIG. 1B, a master valve (MV) (125), a surface safety valve (SSV) (127), and a wing valve (WV) (129) are depicted. The MV (125) controls all flow from the wellbore. For safety considerations, a MV (125) is usually considered so important that two master valves (MVs) (second not shown) are used wherein one acts as a backup. Like unto the SSSV (123), the SSV (127) is a valve installed on the upper portions of the wellbore to provide emergency closure and stoppage of flow. Again, SSVs (127) are designed to close on failure. One or more WVs (129) may be located on the side of the tree (124) section, or on temporary surface flow equipment (not shown). WVs (129) may be used to control and isolate production fluids and/or be used for treatment or well-control purposes.

Also shown in FIG. 1B is a control valve (CV) (131) and a pressure gauge (PG) (133). The CV (131) is a valve that controls a process variable, such as pressure, flow, or temperature, by modulating its opening. The PG (133) monitors the fluid pressure at the tree (124) section.

Turning to the flowline (126) section, the flowline (126) transports (128) the fluid from the well to a storage or processing facility (not shown). A choke valve (139) is disposed along the flowline (126). The choke valve (139) is used to control flow rate and reduce pressure for processing the extracted fluid at a downstream processing facility. In particular, effective use of the choke valve (139) prevents damage to downstream equipment and promotes longer periods of production without shut-down or interruptions. The choke valve (139) is bordered by an upstream pressure transducer (135) and a downstream pressure transducer (137) which monitor the pressure of the fluid entering and exiting the choke valve (139), respectively. The flowline (126) shown in FIG. 1B has a block and bleed valve system (141) which acts to isolate or block the flow of fluid such that it does not reach other downstream components. The flowline (126) may be configured with a multiphase flow meter (MPFM) (143). The MPFM (143) monitors the flow rate of fluid by constituent. That is, the MPFM (143) may detect the instantaneous amount of gas, oil, and water. As such, the MPFM (143) indicates percent water cut (% WC) and the gas-to-oil ratio (GOR). Additionally, the MPFM (143) may measure pressure and fluid density.

The various valves, pressure gauges and transducers, sensors, and flow meters depicted in FIG. 1B may be considered devices of an oil and gas field. As shown, these devices may be disposed both above and below the surface of the Earth. These devices are used to monitor and control components and sub-processes of an oil and gas field. It is emphasized that the plurality of oil and gas field devices depicted in FIG. 1B are non-exhaustive. Additional devices, such as electrical submersible pumps (ESPs) (not shown) may be present in an oil and gas field with their associated sensing and control capabilities. For example, an ESP may monitor the temperature and pressure of a fluid local to the ESP and may be controlled through adjustments to ESP speed or frequency.

The plurality of oil and gas field devices may be distributed local to the sub-processes and associated components, global, connected, etc. The devices may be of various control types, such as a programmable logic controller (PLC) or a remote terminal unit (RTU). For example, a programmable logic controller (PLC) may control valve states, pipe pressures, warning alarms, and/or pressure releases throughout the oil and gas field. In particular, a programmable logic controller (PLC) may be a ruggedized computer system with functionality to withstand vibrations, extreme temperatures, wet conditions, and/or dusty conditions, for example, around a pipeline (120). With respect to an RTU, an RTU may include hardware and/or software, such as a microprocessor, that connects sensors and/or actuators using network connections to perform various processes in the automation system. As such, a distributed control system may include various autonomous controllers (such as remote terminal units) positioned at different locations throughout the oil and gas field to manage operations and monitor sub-processes. Likewise, a distributed control system may include no single centralized computer for managing control loops and other operations.

In accordance with one or more embodiments, FIG. 1B depicts a supervisory control and data acquisition (SCADA) system (145). A SCADA system (145) is a control system that includes functionality for device monitoring, data collection, and issuing of device commands. The SCADA system (145) enables local control at an oil and gas field as well as remote control from a control room or operations center. To emphasize that the SCADA system (145) may monitor and control the various devices of an oil and gas field, dashed lines connecting the plurality of oil and gas field devices to the SCADA system (145) are shown in FIG. 1B.

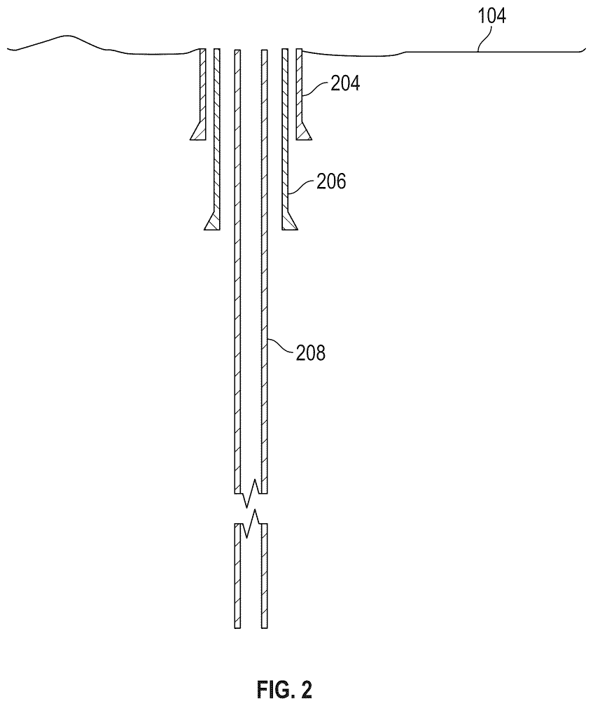

FIG. 2 depicts the casing and production tubing of a well. In the example of FIG. 2, the well has an outer casing (204), an inner casing (206), and production tubing (208). One with ordinary skill in the art will recognize that a well may be configured in a variety of ways and that the instant disclosure is not limited to the depiction of FIG. 2. Further, it is noted that production tubing (208), casings (204, 206), and pipelines associated with a well may all be more generally described as pipes. For example, in FIG. 2, depending on the depth the wellbore may be enclosed by only production tubing (208), production tubing (208) and the inner casing (206), or production tubing (208), inner casing (206), and outer casing (204). In all cases, the surrounding conduit(s) can be referred to as pipe. That is, the term pipe, although conventionally singular, may refer to more than one pipe. Additionally, embodiments disclosed herein, as will be described, can be used to predict the corrosion of other pipes, such as the flowline (126) or the pipes of other systems (e.g., downstream gas processing plant).

Throughout the lifetime of a well, corrosion continually affects the production tubing, casings, and pipelines associated with the well. The corrosion stems from chemical, electrochemical, and mechanical processes and requires costly repair and maintenance operations to prevent the loss of produced hydrocarbons. If left unchecked, corrosion may result in negative environmental impacts and/or the abandonment of a pipeline. To properly maintain a pipeline, reduce repair and maintenance costs, mitigate negative environmental impacts, prevent unscheduled downtime, effectively model a network of well (i.e., an oil and gas field of connected wells), and optimize hydrocarbon production, the corrosion of a well should be assessed.

To assess the integrity of a pipeline and inform well development and production plans, various corrosion inspection tools and methods have been developed. Conventionally used corrosion inspection tools may include ultrasonic tools, electromagnetic (EM) tools and magnetic flux leakage (MFL) tools. While each of these tools may provide a useful indication of corrosion, they are each limited in their inspection capabilities.

For example, aspects of a well are often associated with, or take place in, a high temperature and a high pressure environment. In many instances operational difficulties and well intervention obstacles prevent the use of conventional corrosion logging practices for wells. For example, the lateral line inspection to perform image logging inspection (ILI) is not attainable in many pipe conditions due to the requirements of a launcher and a receiver for ILI tools. As another example, in instances where an oil and gas operator or manager oversees many wells (e.g., thousands of wells), conventional logging practices (e.g., using coil tubing and a measurement device) can be challenging if not untenable; especially with offshore wells.

In one aspect, embodiments disclosed herein relate to a set of machine learning models for determining the corrosion of a well (e.g., well casing) based on observable parameters of the well. As will be described later in the instant disclosure, the observable parameters can include: an age of the well; measured properties of the fluid produced by the well including salinity and hydrogen sulfide (H2S) concentration; downhole temperature; pipe thicknesses; scale thickness; and the depth and source of produced fluid constituents such as H2S and carbon dioxide (CO2). Each machine-learned model in the set of machine learning models can process the inputs to produce a corrosion metric. The corrosion metric can be, for example, a quantity of metal loss, a percentage of metal loss, a rate of metal loss, or some other indicator of corrosion. Embodiments disclosed herein can be discussed as a corrosion prediction system that makes use of one or more machine-learned models and is communicatively coupled to devices of the well to obtain well data (e.g., observable parameters of the well). In instances where more than one well form a network, the corrosion prediction system can also include a network model. In one or more embodiments, the network model is a simulation of the flow of production fluids from each well and throughout the network. The network model receives, or is parameterized, according to a predicted corrosion metric for each well of the network. Thus, using the network model, the integrity of pipelines associated with the wells (e.g., flowlines, downstream gas processing plant(s), etc.) can be assessed. For example, the impact on field production due to corrosion at a well can be determined. Additionally, the network model can consider or simulate flow dynamics in the associated pipelines of the networked wells and all connected facilities (e.g., downstream facilities). For example, the network model can locate areas where flow velocity is high, flow is turbulent, or the flow is expected to have high concentrations of H2S, CO2, ammonia, and other corrosive molecules. The corrosion prediction can identify and alert users to a leak or safety hazard before the leak or safety hazard occurs. Additionally, use of the corrosion prediction system at least reduces—if not fully eliminates—the need to schedule a well for conventional logging. This is particularly useful in scenarios where the location readiness and logistics of conducting a conventional log have a negative impact on job execution. For example, an operator may elect to defer a conventional corrosion log due to complexity of conducting the log which is not safe practice.

Machine learning, broadly defined, is the extraction of patterns and insights from data. The phrases “artificial intelligence,” “machine learning,” “deep learning,” and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning (ML) will be adopted herein, however, one skilled in the art will recognize that the concepts and methods detailed hereafter are not limited by this choice of nomenclature.

In accordance with one or more embodiments, the set of machine learning models includes at least one machine-learned model. More generally, it may be said that the set of machine learning models includes N machine-learned models where N≥1. In one or more embodiments, each of the N machine-learned models is a so-called supervised learning model trained using historical data. Training of the machine-learned models is described in greater detail later in the instant disclosure. In one or more embodiments, the set of machine learning models includes three machine-learned models of different types, specifically, a neural network, a random forest, and a support vector machine. More details regarding these types of machine learning models are provided later in the instant disclosure. In general, these ML models are configured according to one or more “hyperparameters” which further describe the models. For example, hyperparameters providing further detail about the random forest may include, but are not limited to, the number of decision trees in the forest and the configuration of a bootstrapping process, if used. The selection of hyperparameters may be informed through evaluation of a model performance metric (e.g., mean squared error) using labelled data (i.e., known corrosion target) during the training process.

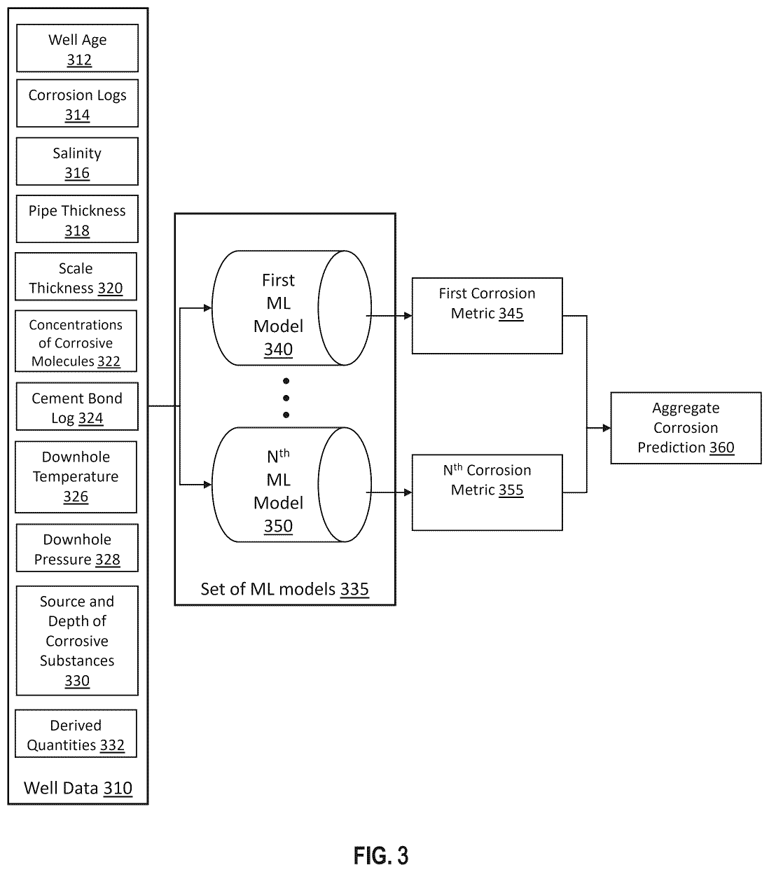

In accordance with one or more embodiments, FIG. 3 depicts the determination of an aggregate corrosion prediction (360) for a well. As depicted in FIG. 3, a set of machine learning (ML) models (335) is used to determine an aggregate corrosion prediction (360). In particular, FIG. 3 depicts a first machine learning model (340) and an Ni machine learning model (350) where N≥1. As seen, each ML model (240) is used to determine a corrosion metric. Specifically, the first ML model (340) is used to determine a first corrosion metric (345) and the N^{th} machine learning model (350) is used to determine a N^{th} corrosion metric (355). In one or more embodiments, the set of ML models (335) includes three ML models including a neural network, random forest, and support vector machine. That is, in one or more embodiments, N=3 and the set of ML models (335) includes a first ML model (340), a second ML model (not depicted), and a third ML model (350) where the first ML model (340) is a neural network, the second ML model is a random forest, and the third ML model (350) is a support vector machine. In one or more embodiments, the neural network, random forest, and support vector machine are specifically designated herein because of their distinct operational strengths in view of the well data (310) on which they process. In particular, the IF is effective in identifying anomalies by isolating data points. Additionally, once trained, these ML models can be continually updated and improved as new data is collected, allowing them to adapt to changing conditions in the well environment and reservoir.

As seen in FIG. 3, each ML model in the set of ML models (335) processes, as inputs, well data (310). In accordance with one or more embodiments, the well data (310) can include, but is not limited to: well age (312); corrosion logs (314); salinity measurements (316); pipe thickness data (318); scale thickness data (320); concentration data including the concentrations of corrosive molecule such as H2S and CO2 (322); cement bond logs (324); downhole temperature data (326); downhole pressure data (328); data relating to the source and depth of corrosive substances (e.g., H2S) (330); and possibly derived quantities (332). The well data (310), in most instances, can be considered a measurement of observable parameters of a well. In one or more embodiments, the well data (310) is acquired using devices of the well as previously described (e.g., PDHMS, MPFM, and other sensors such as concentration sensors). In greater detail, the well age (312) indicates the current age, or time since initial operation, of the well (e.g., in years). The corrosion logs (314) can contain historical measurements of corrosion acquired at locations of a pipe using conventional tools or methods. For example, the corrosion logs (314) can have historical measurements of corrosion at one or more locations of a pipe. The salinity data (316) includes a measurement of the salinity of the fluid produced by the well. The pipe thickness data (318) can indicate the initial thickness, and in some instances also the material type (e.g., a specified steel), of the pipe. The scale thickness data (320) includes a measurement of scale build up at one or more locations of the well. The concentration data (322) indicates the concentration of one or more corrosive molecules in the fluid produced by the well. Corrosive molecules can include, for example, H2S, CO2, and ammonia. In some instances, the concentration data (322) is, or includes, a measurement of acidity (e.g., pH). The cement bond log (324) is a measurement of the integrity of the cement within the wellbore. For example, the cement bond log (324) indicates whether the cement is adhering solidly to the outside of the casing. The cement bond log (324) can be obtained, for example, using one of a variety of sonic-type tools. The downhole temperature (326) indicates the temperature at a downhole location of the well (e.g., acquired using PDHMS or other downhole temperature sensor). Similarly, the pressure data (328) indicates the pressure at a downhole location of the well. Additionally, the well data (310) can include corrosive substance data (330) indicating the depth and source of one or more corrosive substances (e.g., H2S) (i.e., a subsurface formation where a corrosive substances originates). Finally, in some instances, the well data (310) further includes one or more derived quantities (332). A derived quantity is a quantity or value developed using at least one measured value. For example, a derived quantity may include a rate of metal loss (i.e., a measure of corrosion) with respect to salinity (316). That is, in this example a salinity corrosion rate (i.e., a derived quantity (332)) is determined using both the salinity data (316) and the corrosion logs (314). As another example, a general corrosion rate can be determined using corrosion logs (314) acquired over a period of time (or corrosion logs (314) acquired at a same location of a well at a least two temporally distinct instances). For example, if a casing diameter is 220 millimeters in a first log acquired at a first time and became 180 millimeters in a second log acquired at a second time, the second time occurring 6 years after the first time, then the corrosion rate is 6.7 millimeters/year. Derived quantities (332) can also be developed as part of a feature engineering process without exceeding the scope of the instant disclosure. An example of feature engineering consists of a polynomial expansion (e.g., taking the square), up to a given order, of one or more measured values. Derived quantities may be developed, tested, and/or selected as part of a feature engineering process when training the ML models. Feature engineering and training are described in greater detail later in the instant disclosure. Finally, it is noted that not all of the listed components of the well data (310) of FIG. 3 need be included as part of the well data (310). One or more embodiments can use fewer well data (310) elements than that depicted in FIG. 3. For example, in one or more embodiments, the well data (310) does not include a cement bond log (324).

In accordance with one or more embodiments, and as seen in FIG. 3, each of ML models in the set of ML models (335) process the well data (310) and outputs a corrosion metric such as a percentage of metal loss. Specifically, the first ML model (340) returns a first corrosion metric (345), the second ML model (350) returns a second corrosion metric, and so on and so forth for all of N ML models in the set of ML models (335). In accordance with one or more embodiments, the produced corrosion metrics (i.e., the first through the N^{th} corrosion metrics returned by the first through the Ni ML models) are aggregated to form an aggregate corrosion prediction (360) using an aggregation function.

The aggregate corrosion prediction (360) can be used, for example, to predict a leak or other safety hazard. In one or more embodiments, in response to the aggregate corrosion prediction (360), one or more remedial actions can be applied to the well or affected area. For example, dependent on the severity and location of the predicted corrosion, remedials actions may include, but are not limited to: using a casing patch to reline casing or tubing; squeeze cementing; use of pack-off to partially or completely block the circulation of fluid near the affected area; a workover procedure that may include the removal and replacement of production tubing and casing(s). In one or more embodiments, the aggregate corrosion prediction (360) is used to identify a corroded location, or a location to be corroded within a given timeframe, and initiate a remedial action to repair the identified location before a workover procedure is required. That is, an area of corrosion in the well can be detected based on the aggregate corrosion prediction (360).

Various aggregation functions can be used to form the aggregate corrosion prediction (360). For example, in one implementation, the aggregate corrosion prediction (360) is simply the corrosion metric associated with the ML model that has the highest confidence with respect to the input well data (310). In another implementation, the aggregation function forms the aggregate corrosion prediction (360) as the weighted average of the corrosion metrics. In other implementations, the possible values of an instance of well data (310) are said to span a data space (e.g., hyperspace) and the data space is partitioned into two or more regimes. For example, in one or more embodiments, the data space is partitioned into regimes labelled a first through an Ni regime, the first through N^{th} regimes being mutually exclusive and their union exhausting the data space. In such an implementation, the first corrosion metric (345) can be selected and used as the aggregate corrosion prediction (360) when the well data (310) resides within the first regime. Similarly, in such an implementation, the N^{th} metric (355) is selected and used as the aggregate corrosion prediction (360) when the well data (310) resides within the N^{th} regime. That is, in one or more implementations, the ML models of the set of ML models (335) can be said to have complementary modalities of discrimination, where one model is more apt (or more accurate) at predicting corrosion under a certain set of conditions (i.e., encompassed and defined by a regime in the data space) relative to the other model(s). In instances where the aggregation function represents a weighted average of two or more anomaly metrics, the weights assigned to each model may be given according to a regime in which the input resides. In another example, a confidence level is associated with at least one of two or more corrosion metrics. In this example, the aggregation function can consist of a weighted average of the corrosion metrics, where the weights correspond to the confidence level of at least one of the predictions. For example, considering the case where N=2, in one or more embodiments, the weight assigned to the first corrosion metric (345) and the weight assigned to the second corrosion metric (355) when the aggregation function is a weighted average is w₁ and w₂, respectively. Further, the confidence level associated with the first corrosion metric (345) and the confidence level associated with the second corrosion metric (355) is c₁ and c₂, respectively, where c₁ and c₂ need not sum to 1 and, in some instances, either c₁ and c₂ can be based on the other. Using this notation, in one or more embodiments, the weights used in the aggregation function are determined using the softmax function as

$${w}_{1} = \frac{exp ( {c}_{1} )}{exp ( {c}_{1} ) + exp ( {c}_{2} )} and {w}_{2} = \frac{exp ( {c}_{2} )}{exp ( {c}_{1} ) + exp ( {c}_{2} )} .$$

In one or more embodiments, the ML models of the set of ML models (335) operate synergistically. That is, the ML models do not necessarily operate independently. For example, in one or more embodiments, ML models of the set of ML models (335) operate in a hierarchical manner where one model's output informs the focus or parameter settings of the other(s). For example, in some embodiments, a first ML model (340) processes well data (310) to determine a first corrosion metric (345). Then, the well data (310) and the first corrosion metric (345) are processed, as inputs, by a second ML model to produce a second corrosion metric (355). In this case, the second corrosion metric (355) can be directly taken as the aggregate corrosion prediction (360). In other embodiments, a first ML model (340) processes well data (310) to determine a first corrosion metric (345) and rather than passing the first corrosion metric (345) as an input to a second ML model, the first corrosion metric (345) is used to inform (or adjust) the parameters of the second ML model. For example, consider notation where the first ML model (340) is represented as a function ƒ₁ that produces an output y₁ given an input x, the function parameterized by parameters β₁ (i.e., y₁=ƒ₁(x:β₁)). Likewise, consider a notation where a second ML model is represented as a function ƒ₂ that produces an output y₂ given an input x, the function parameterized by parameters β₂ (i.e., y₂=ƒ₂(x:β₂)). Thus, in some embodiments, the informed nature of the second ML model, being informed by the first ML model (340), can be represented mathematically as y₂=ƒ₂(x:β₂(y₁)). That is, the parameterization of the second ML model is dependent on the output (i.e., first corrosion metric (345)) of the first ML model (340). In one or more embodiments, the input and/or parameterization of the first ML model (340) is based on an output of a second ML model and, similarly, the input and/or parameterization of a second ML model can be based on the output of the first ML model (340). In these embodiments, an initial (or null) output can be used to initialize either of the first, second, third, etc. of ML model and the subsequent output can be used to as input (and/or parameterization) to the other ML model(s). This may form an iterative process of interaction between two or more ML models that proceeds until a stopping criterion such as a number of iterations.

In summary, the synergistic operation of the set of ML models (335) can be implemented in a variety of ways in accordance with one or more embodiments, such as using the outputs of a model as inputs or contextual modifiers (e.g., dependent parametrization) for another and/or iterative processes that continually refines the model predictions. Further, the aggregate corrosion prediction (360) can be formed using one or more corrosion metrics. For example, in instances where two or more ML models interact iteratively, the aggregate corrosion prediction (360) can be set equal to any of the output corrosion metrics upon determination of convergence in the predictions.

Benefits of synergistic operation are described with respect to specific ML model types. Consider the case where N=3 and the first ML model (340) is neural network, the second ML model a random forest, and the third ML model (350) is a support vector machine. In accordance with one or more embodiments, the neural network, random forest, and support vector machine are specified for their complementary predictive capabilities. For example, while random forests are generally computationally efficient in quickly determining a tree path and forming a corrosion metric, they may not always be precise in high-dimensional spaces where well data and associated corrosion values are not well-separated. In contrast, support vector machines excel in these environments. Continuing, neural networks may be considered adept at discovering or forming complex interactions between features and may be said to perform their own feature engineering. However, as a consequence, neural network may be more prone to overfitting than a random forest and less efficient than a support vector machine. By combining these models, the methods and systems disclosed herein leverage the benefits of each model type and can determine an accurate aggregate corrosion prediction (360) using a tailored aggregation function (e.g., selection of the model with the highest confidence according to a data regime). Moreover, the synergistic integration of these models can be implemented either sequentially or in parallel. In a sequential setup, one model's output can refine the input for the others (as described above), enhancing the overall accuracy. In parallel processing, all models independently analyze the data, and their results are aggregated (e.g., a weighted sum) to make the final decision on corrosion. Additionally, the synergistic integration of these models allows for cross-validation and feedback. In particular, results from each model can be used to cross-validate the findings of the other. For instance, if the models independently determine the same value for corrosion, then the corrosion value can be considered with higher confidence. Conversely, if there's a discrepancy (e.g., one model identifies a data point as associated with a large amount of corrosion while another model associates it with a low amount of corrosion), it can trigger a deeper analysis and/or be annotated with a cautionary warning with respect to using the aggregate corrosion prediction (360) in subsequent systems (e.g., network model).

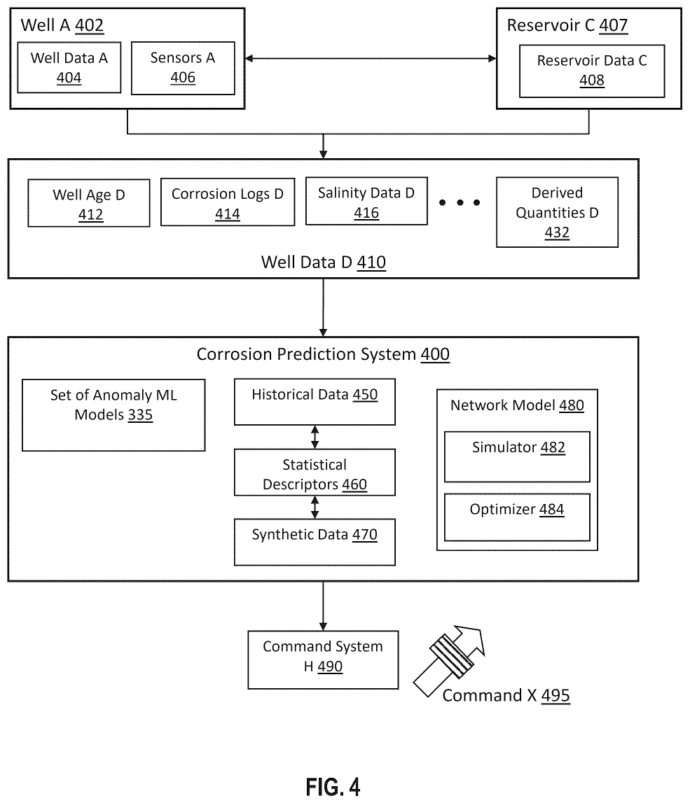

In some implementations, methods and systems of the instant disclosure are effectuated as a corrosion prediction system. Turning to FIG. 4, FIG. 4 depicts an instance of a corrosion prediction system (400) in accordance with one or more embodiments. As seen in FIG. 4, the corrosion prediction system (300) interacts with a well (e.g., Well A (402)) with access to a reservoir (e.g., Reservoir C (407)). One or more sensors (e.g., Sensors A (406)) are disposed on or within the well (e.g., devices as described above). The sensors may include one or more temperature sensors, pressure sensors, vibration sensors, and flow rate sensors (including multiphase flowrate devices (e.g., MPFM)), concentration sensors, among other sensors.

Sensor data, and other data related to the well (e.g., Well A (402)) is collected as well data (e.g., Well Data A (404)). Additional data, associated with the reservoir (e.g., Reservoir C (407)) can be collected as reservoir data (e.g., Reservoir Data C (408)). Reservoir data can be collected using one or more sensors associated with the well, one or more sensors associated with the reservoir, data collected as part of a drilling process (e.g., logging while drilling data), data collected apart from a drilling process (e.g., seismic survey), or any combination thereof.

As seen in FIG. 4, well data (e.g., Well data D (410)) can include well age data (e.g., Well Age D (412)), corrosion logs (e.g., Corrosion Logs D (414)), salinity data (e.g., Salinity Data D (416)), derived quantities (e.g., Derived Quantities D (432)), among other types of data (e.g., downhole temperature data, concentration data, scale data, pipe data such as thickness and material type (e.g., grade)) as described above. For concision, examples of elements of the well data previously described are not repeated.

As understood, the well data can include quantities that can vary with time (e.g., temperature, pressure, etc.). As such, an instance (or a single “input” from the perspective of the set of ML models (335)) may be composed of the measured or known properties of well and reservoir (collected as well data) at a given time.

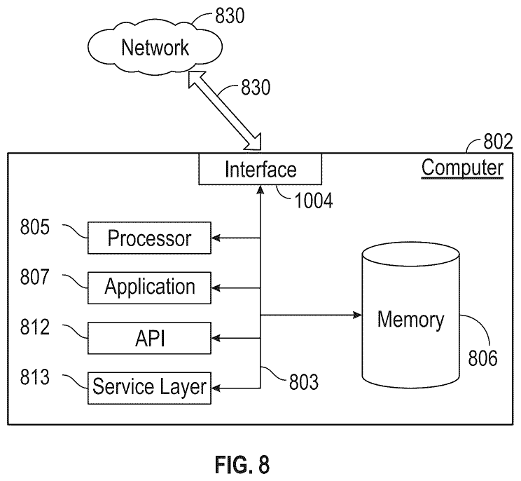

While not depicted in FIG. 4, the well (e.g., Well A (402)) can also be associated with one or more configurable well parameters. In one or more embodiments, and as described below, the corrosion prediction system (400) can control various operations of the well (e.g., Well A (402)) through manipulation of the configurable parameters. That is, in one or more embodiments, the corrosion prediction system (400) can command one or more configurable parameters of a well to assume a specified value or setting. As such, in some embodiments, the corrosion prediction system (400) includes a computer system that is the same as or similar to that of computer system depicted in FIG. 8 with its accompanying description. In accordance with one or more embodiments, the configurable parameters of the well may include valves, such as production valve and inflow control valves near the surface, controllers of a permanent downhole monitoring system (PDHMS) and associated devices, one or more tools for logging, one or more choke assemblies, and one or more electrical submersible pumps. In some embodiments, the configurable parameters are received, adjusted, or otherwise interacted with using a command system (e.g., Command System H (490)), for example, a SCADA system.

Continuing with FIG. 4, and in accordance with one or more embodiments, the well (e.g., Well Data D (410)) is passed to or otherwise provided to the corrosion prediction system (400). In accordance with one or more embodiments, the corrosion prediction system (400) includes a set of ML models (335). In one or more embodiments, the set of ML models (335) includes a first, second, and third ML model having a type of a neural network, a random forest, and a support vector machine, respectively. As discussed with respect to FIG. 3, the well data (e.g., Well Data D (410)) is processed by the set of ML models (335) to produce an aggregate corrosion prediction (360). The aggregate corrosion prediction can be used by one or more other components or elements of the corrosion prediction system (400) as described below.

In accordance with one or more embodiments, the corrosion prediction system (400) includes, or has access to, historical data (450). The historical data includes, at least, historical well data such as corrosion logs that can be used, when desired, to train (or re-train, fine-tune, etc.) the set of ML models (335).

In one or more embodiments, the corrosion prediction system (400) further includes, or is capable of determining, one or more statistical descriptors (460) based on the historical data (450). For example, the statistical descriptors (460) can be composed of one or more descriptive statistics applied to the historical data (450) such as the minimum, maximum, mean, standard deviation, variance, kurtosis, etc. In one or more embodiments, the statistical descriptors (460) can be used to generate a set of synthetic data (470) to train or further augment the training data of the set of ML models (335). For example, the statistical descriptors (460) can define a distribution from which synthetic data points can be sampled or drawn to form synthetic data (470). The use of statistical descriptors (460) based on historical (or real) data (450) promotes a realness in the synthetic data (470). That is, the set of ML models (335) trained using synthetic data (470), in full or in part, will mimic the behavior ML models trained using only historical data in the same quantity of data.

In accordance with one or more embodiments, the corrosion prediction system (400) further includes a network model (480). In one or more embodiments, the network model (480) includes a simulator (482) and an optimizer (484). The simulator (482) includes a digital representation of one or more wells and their interaction including physics-based and/or phenomenological models of the well production. For example, in one or more embodiments, the simulator (482) is a computational fluid dynamics (CFD) or finite element analysis (FEA) model of the flow of fluid from wells and through a well network to, and possibly through, a downstream process such as a processing plant. The simulator (482) can thus simulate the effect of corrosion at various wells to the overall hydrocarbon production and the health (e.g., corrosion) of other components (e.g., downstream pipelines) of the oil and gas field.

In one or more embodiments, the network model (480) uses the simulator (482) to simulate the flow of production fluids from each well and throughout the network. The network model (480) receives, or is parameterized, according to a predicted corrosion metric for each well of the network, where the predicted corrosion is determined using the set of ML models (335) as previously described. Thus, using the network model (480) (specifically, the simulator (482)), the integrity of pipelines associated with the wells (e.g., flowlines, downstream gas processing plant(s), etc.) can be assessed. For example, the impact on field production due to corrosion at a well can be determined. Additionally, the network model (480) can consider or simulate flow dynamics in the associated pipelines of the networked wells and all connected facilities (e.g., downstream facilities). For example, the network model (480) can locate areas where flow velocity is high, flow is turbulent, or the flow is expected to have high concentrations of H2S, CO2, ammonia, and other corrosive molecules.

The network model (480), through use of the optimizer (484) can further be used to determine a set of optimal operation parameters (i.e., well control parameters) that optimize the aspects of the well network (e.g., hydrocarbon production) according to a given performance metric. The performance metric can quantify one or more aspects of a well or network of wells such as: the production of hydrocarbons from a well; and the cost of operating the well network.

In one or more embodiments, the set of ML models (335), can be described as a function relating the inputs (e.g., well data) and the output (i.e., aggregate corrosion prediction). That is, the set of ML models (335) can be mathematically represented as M=corrosion prediction=ƒ(well data data), such that, given an input of well data, the trained set of ML models may produce an aggregate corrosion prediction for one or more wells. In accordance with one or more embodiments, a performance metric is based on the aggregate corrosion prediction (360). Herein, the performance metric is represented by the variable P and it is assumed that the given performance metric is configured such that increased values of P represent better performance (i.e., optimization can be represented as a maximization of P). Thus, representing the performance metric as a function g, the performance of one or more wells can be given as P=g(aggregate corrosion prediction). Thus, with trained ML models an optimization wrapper can be used to invert the models to determine the set of optimal operation parameters that maximize the performance P according to a performance metric.

$${arg max}_{{S}_{1}} P \qquad ( 1 )$$

$$subject to : device constraints$$

where the set of operation parameters is denoted as S₁. Thus, the optimization wrapper maximizes the performance, according to a performance metric, over the set of operation parameters. The optimization wrapper, when applied to trained ML models parameterized by the set of operation parameters, returns a set of optimal operation parameters. Optimization algorithms that may be employed by the optimization wrapper include, but are not limited to: genetic algorithm, Newton conjugate gradient (Newton-CG), Broyden-Fletcher-Goldfarb-Shanno (BFGS), and limited-memory BFGS (L-BFGS) algorithms.

One with ordinary skill in the art will appreciate that maximization and minimization may be made equivalent through simple techniques such as negation. As such, the choice to represent the optimization as a maximization as shown in EQ. 1 does not limit the scope of the present disclosure. Whether done through minimization or maximization, the optimization wrapper identifies the set (or sets) of operation parameters that optimize performance of one or more wells according to a given performance metric (e.g., hydrocarbon production) based on the trained set of ML models (335) and associated aggregation function.

Additionally, it is recognized that a well may be subject to constraints, such as safety limits imposed on various devices of the well. For example, it may be determined that in order for a well to operate safely, an ESP should be operated at a frequency not to exceed a predefined frequency. In one or more embodiments, the optimization wrapper cannot elect any set of operation parameters that cause any portion of a well to exceed predefined device constraints.

Keeping with FIG. 4, and in accordance with one or more embodiments, at least the aggregate corrosion prediction (360) is transmitted automatically and in real-time over a distributed network or through a physical mechanism for data transfer such as fiber optic cables via a command system (e.g., Command System H (490)). In other instances, the corrosion prediction system (400) may further transmit a set of optimal operation parameters determined using the optimizer (484) and based on the output of the set of ML models (335). The command system may be a controller such as a programmable logic controller (PLC). The command system may further include a computer that is the same as or similar to that of computer system depicted in FIG. 8 with its accompanying description. Based on the aggregate corrosion prediction (360) and other outputs or products of the corrosion prediction system (400) (e.g., set of optimal operation parameters), the command system (e.g., Command System H (490)) transmits a signal or command to update one or more parameter values, the one or more parameters belonging to the set of operation parameters. The command to update or modify the state of the set of operation parameters is represented by Command X (495) in FIG. 4.

The aggregate corrosion prediction (360) can be used, for example, to predict a leak or other safety hazard. In one or more embodiments, the transmission of the corrosion prediction (360) triggers the selection and application of one or more remedial actions to be applied to the well or affected area. For example, dependent on the severity and location of the predicted corrosion, remedials actions may include, but are not limited to: using a casing patch to reline casing or tubing; squeeze cementing; use of pack-off to partially or completely block the circulation of fluid near the affected area; a workover procedure that may include the removal and replacement of production tubing and casing(s). In one or more embodiments, the aggregate corrosion prediction (360) is used to identify a corroded location, or a location to be corroded within a given timeframe, and initiate a remedial action to repair the identified location before a workover procedure is required. That is, an area of corrosion in the well can be detected based on the aggregate corrosion prediction (360). In one or more embodiments, the severity of the aggregate corrosion prediction (360) is determined by comparing a value of the aggregate corrosion prediction (360) to a predefined threshold. For example, in one or more embodiments, a remedial action is determined in response to the corrosion prediction (360) exceeding the threshold.

In accordance with one or more embodiments, the set of ML models (335) is used to determine an optimal set of operation parameters using the optimizer (484) to optimally operate the one or more wells. For example, the optimal set of operation parameters may maximize oil production from a well. Upon determining the set of optimal operation parameters, the set of optimal operation parameters may be applied to a well automatically. In one or more embodiments, hydrocarbon production (i.e., a given performance metric) is continuously monitored by at least one device (e.g., sensor) of the well network to ensure that the determined set of optimal operation parameters improve the hydrocarbon production.

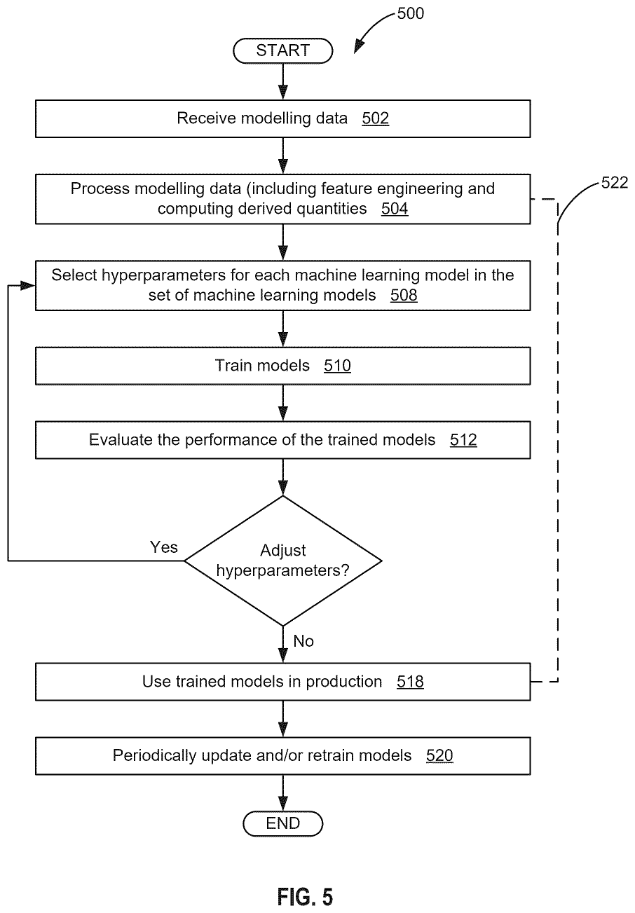

FIG. 5 depicts the general process of training and selecting the hyperparameters (also known as model tuning) for the one or more ML models in the set of ML models (335), in accordance with one or more embodiments. The processes shown in FIG. 5 may be applied to obtain the trained the ML models individually, or in conjunction with one another. To start, as shown in Block 502, modelling data is received. The modelling data consists of example data points and associated labels (i.e., corrosion metric). In one or more embodiments, the modelling data are acquired from historical operation data (e.g., historical data (450)). In other embodiments, modelling data are formed from, or includes in addition to the historical data (450), synthetic data (470) generated using statistical descriptors (460) based on the historical data (450).

Keeping with FIG. 5, in one or more embodiments, the modelling data are preprocessed as depicted by Block 504. Preprocessing, at a minimum, includes altering the modelling data so that it is suitable for use with ML models. For example, removing or imputing data entries with missing values. Information surrounding the preprocessing steps is saved for potential later use. For example, if normalization is performed then a computed mean vector and variance vector are retained. This allows future modelling data to be preprocessed identically. Values computed and retained during preprocessing are referred to herein as preprocessing parameters. One with ordinary skill in the art will recognize that a myriad of preprocessing methods beyond numericalization, removal of modelling data entries with missing values, normalization, and imputation exist. Descriptions of a select few preprocessing methods herein do not impose a limitation on the preprocessing steps encompassed by this disclosure.

In one or more embodiments, the modelling data is partitioned into two or more sets of data such as a training dataset and a validation set. In some embodiments, the modelling data is partitioned into a training dataset, a validation dataset, and a testing dataset. Methods for partitioning the training data into different datasets include randomly selecting datapoints and their associated targets (e.g., corrosion values) from the modelling data according to some sampling percentage. For example, the training dataset may include 80% of the modelling data while the validation and testing datasets each contain 10% of the modelling data.

In Block 508, the hyperparameters for each ML model in the set of ML models (335) are selected (e.g., number of trees in a random forest, strength of a support vector machine boundary relaxation, number of hidden layers in a neural network, regularization parameter, type of activation function, etc.). Once selected, the set of ML models (335) is trained using the training data according to Block 510. Common training techniques, such as early stopping, adaptive or scheduled learning rates, and cross-validation may be used during training without departing from the scope of this disclosure.

During training, or once trained, the performance of the set of ML models (335) may be evaluated as depicted in Block 512. For example, a performance metric such as the means squared error can be used to compare the predicted corrosion metrics of each ML model of the set of ML models (335) to a known target corrosion metric over a validation dataset.

At Block 514, a determination is made as to whether the hyperparameters of the ML models needs to be altered. This decision may be based on the evaluation of the models as determined in Block 512. For example, if the performance of the ML models, as determined in Block 512, is suitable, then the ML models are accepted for use in a production setting. As such, in Block 518, the set of ML models (335) are used in production. At Block 514, if the performance of the trained ML models are not suitable, the hyperparameters may be altered (i.e., return to Block 508) and the training process is repeated. There are many ways to alter the hyperparameters in search of suitable trained ML model performances. These include, but are not limited to: selecting new sets of hyperparameters from previously defined sets; randomly perturbing or randomly selecting new hyperparameters; using a grid search over the available hyperparameters; and intelligently altering hyperparameters based on the observed performance of previous models (e.g., a Bayesian hyperparameter search). Once suitable performance is achieved, the training procedure is complete, and the models are used in production as depicted in Block 518.

As depicted in Block 518, the set of ML models (335) is used “in production”-which means, as previously stated, that the trained ML models are used to process a received input not previously seen or used during training (e.g., a real-time data point). It is emphasized that the inputs received in the production setting are preprocessed identically to the manner defined in Block 504 as denoted by the connection (522), represented as a dashed line in FIG. 5, between Blocks 518 and 504.

In accordance with one or more embodiments, the set of ML models (335) is periodically updated using the data acquired in the production setting. An update may include retraining one or more ML models, by reverting to Block 508, with the newly acquired data from the in-production recorded values appended to the training data. An update may also include recalculating any preprocessing parameters, again, after appending the newly acquired training data to the existing training data. Thus, embodiments of the instant disclosure implement continuous learning to account for evolving conditions or new patterns in an evaluated well. In one or more embodiments, the set of ML models (334) is periodically retrained with the most recent data, ensuring the set remains accurate and relevant.

While the various blocks in FIG. 5 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

As stated, in one or more embodiments, the set of ML models (335) includes a neural network, a random forest, and a support vector machine. Simple descriptions of these model types are provided as follows. That said, one with ordinary skill in the art will recognize that many variations of each of these machine-learned models exist. As such, the introductory discussions of a neural network, random forest, and support vector machine provided herein should not be construed as limiting on the instant disclosure.

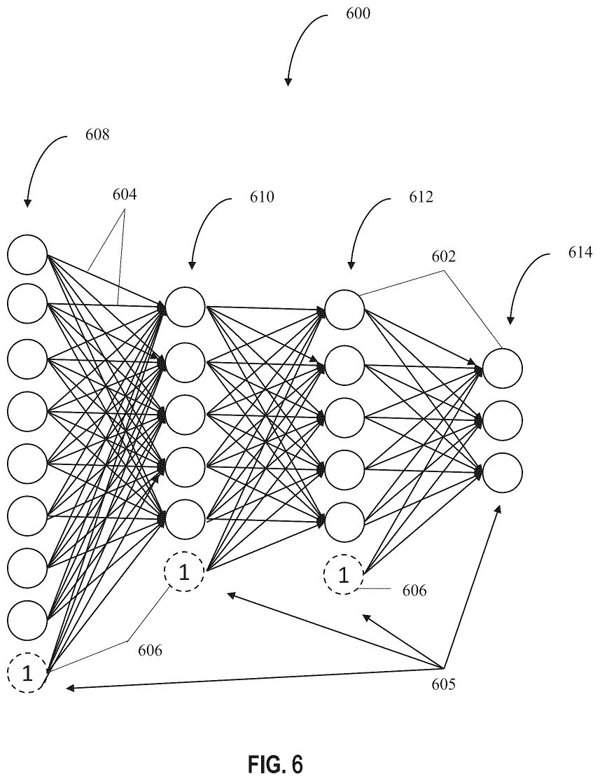

A diagram of a neural network (NN) (600) is shown in FIG. 6. At a high level, a NN (600) may be graphically depicted as being composed of nodes (602), where here any circle represents a node, and edges (604), shown here as directed lines. The nodes (602) may be grouped to form layers (605). FIG. 6 displays four layers (608, 610, 612, 614) of nodes (602) where the nodes (602) are grouped into columns, however, the grouping need not be as shown in FIG. 6. The edges (604) connect the nodes (602). Edges (604) may connect, or not connect, to any node(s) (602) regardless of which layer (605) the node(s) (602) is in. That is, the nodes (602) may be sparsely and residually connected. A neural network (600) will have at least two layers (605), where the first layer (608) is considered the “input layer” and the last layer (614) is the “output layer.” Any intermediate layer (610, 612) is usually described as a “hidden layer.” A neural network (600) may have zero or more hidden layers (610, 612) and a neural network (600) with at least one hidden layer (610, 612) may be described a “deep” neural network or a “deep learning method.” In general, a neural network (600) may have more than one node (602) in the output layer (614). In this case the neural network (600) may be referred to as a “multi-target” or “multi-output” network.

Nodes (602) and edges (604) carry additional associations. Namely, every edge (604) is associated with a numerical value. The edge numerical values, or even the edges (604) themselves, are often referred to as “weights” or “parameters.” While training a neural network (600), numerical values are assigned to each edge (604). Additionally, every node (602) is associated with a numerical variable and an activation function. Activation functions are not limited to any functional class, but traditionally follow the form

$$A = f ( {\sum }_{i ∈ ( incoming )} [ {( node value )}_{i} {( edge value )}_{i} ] ) , \qquad ( 2 )$$

where i is an index that spans the set of “incoming” nodes (602) and edges (604) and ƒ s a user-defined function. Incoming nodes (602) are those that, when viewed as a graph (as in FIG. 6), have directed arrows that point to the node (602) where the numerical value is being computed. Some functions for ƒ may include the linear function ƒ(x)=x, sigmoid function

$$f ( x ) = \frac{1}{1 + {e}^{- x}} ,$$

and rectified linear unit (ReLU) function ƒ(x)=max(0, x), however, many additional functions are commonly employed. Every node (602) in a neural network (600) may have a different associated activation function. Often, as a shorthand, activation functions are described by the function ƒ by which it is composed. That is, an activation function composed of a linear function ƒ may simply be referred to as a linear activation function without undue ambiguity.

When the neural network (600) receives a network input, the network input is propagated through the network according to the activation functions and incoming node (602) values and edge (604) values to compute a value for each node (602) according to EQ. 3. That is, the numerical value for each node (602) may change for each received input. Occasionally, nodes (602) are assigned fixed numerical values, such as the value of 1, that are not affected by the input or altered according to edge (604) values and activation functions. Fixed nodes (602) are often referred to as “biases” or “bias nodes” (606), displayed in FIG. 6 with a dashed circle.

In some implementations, the neural network (600) may contain specialized layers (605), such as a normalization layer, a regularization layer (e.g. dropout layer), and a concatenation layer. One skilled in the art will appreciate that these alterations do not exceed the scope of this disclosure.

As noted, the training procedure for the neural network (600) comprises assigning values to the edges (604). To begin training, the edges (604) are assigned initial values. These values may be assigned randomly, assigned according to a prescribed distribution, assigned manually, or by some other assignment mechanism. Once edge (604) values have been initialized, the neural network (600) may act as a function, such that it may receive inputs and produce an output. As such, at least one input is propagated through the neural network (600) to produce an output. Generally, a dataset, known as a training dataset, is provided to the neural network (600) in order for the network to learn edge (604) values (i.e., learn the network parameters). The training dataset is composed of inputs and associated target(s), where the target(s) represent the “ground truth”, or the otherwise desired output. The neural network (600) output is compared to the associated input data target(s). The comparison of the neural network (600) output to the target(s) is typically performed by a so-called “loss function”; although other names for this comparison function such as “error function,” “misfit function,” and “cost function” are commonly employed. Many types of loss functions are available, such as the mean-squared-error function, however, the general characteristic of a loss function is that the loss function provides a numerical evaluation of the similarity between the neural network (600) output and the associated target(s). The loss function may also be constructed to impose additional constraints on the values assumed by the edges (604), for example, by adding a penalty term, which may be physics-based, or a regularization term. Generally, the goal of a training procedure is to alter the edge (604) values to promote similarity between the neural network (600) output and associated target(s) over the training dataset. Thus, the loss function is used to guide changes made to the edge (604) values, typically through a process called “backpropagation.”

While a full review of the backpropagation process exceeds the scope of this disclosure, a brief summary is provided. Backpropagation consists of computing the gradient of the loss function over the edge (604) values. The gradient indicates the direction of change in the edge (604) values that results in the greatest change to the loss function. Because the gradient is local to the current edge (604) values, the edge (604) values are typically updated by a “step” in the direction indicated by the gradient. The step size is often referred to as the “learning rate” and need not remain fixed during the training process. Additionally, the step size and direction may be informed by previously seen edge (604) values or previously computed gradients. Such methods for determining the step direction are usually referred to as “momentum” based methods.

Once the edge (604) values have been updated, or altered from their initial values, through a backpropagation step, the neural network (600) will likely produce different outputs. Thus, the procedure of propagating at least one input through the neural network (600), comparing the neural network (600) output with the associated target(s) with a loss function, computing the gradient of the loss function with respect to the edge (604) values, and updating the edge (604) values with a step guided by the gradient, is repeated until a termination criterion is reached. Common termination criteria are: reaching a fixed number of edge (604) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (604) values are no longer intended to be altered, the neural network (600) is said to be “trained.”

With respect to a random forest, generally, a random forest is an ensemble of decision trees. A decision tree is composed of nodes. A decision is made at each node such that data present at the node are segmented. Typically, at each node, the data at said node, are split into two parts, or segmented bimodally, however, multimodal segmentation is possible. The segmented data can be considered another node and may be further segmented. As such, a decision tree represents a sequence of segmentation rules. The segmentation rule (or decision) at each node is determined by an evaluation process. The evaluation process usually involves calculating which segmentation scheme results in the greatest homogeneity or reduction in variance in the segmented data. However, a detailed description of this evaluation process, or other potential segmentation scheme selection methods, is omitted for brevity and does not limit the scope of the present disclosure.

Further, if at a node in a decision tree, the data are no longer to be segmented, that node is said to be a “leaf node.” Commonly, values of data found within a leaf node are aggregated, or further modeled, such as by a linear model. A decision tree can be configured in a variety of ways, such as, but not limited to, choosing the segmentation scheme evaluation process, limiting the number of segmentations, and limiting the number of leaf nodes. Generally, when the number of segmentations or leaf nodes in a decision tree is limited, the decision tree is said to be a “weak learner.”

In most implementations, for a random forest, the decision trees are ensembled in parallel, wherein each decision tree makes decisions (or processes a data point through its set of segmentation rules) independent of all other trees in the forest (i.e., the ensemble).

Training a random forest consists of the selection of segmentation rules for each node in each decision tree; that is, training each decision tree. Once trained, a decision tree is capable of processing data. For example, a decision tree may receive a data input. The data input is sequentially transferred to nodes within the decision tree according to the segmentation rules of the decision tree. Once the data input is transferred to a leaf node, the decision tree outputs the assigned value of the associated leaf node which is usually the average value of the target of all data instances assigned to the leaf node.

Generally, training a random forest consists of independently training each decision tree and then averaging, or otherwise aggregating, the results of each decision tree.

With respect to a support vector machine, in general, a support vector machine regressor may be decomposed into two parts. First, a support vector machine regressor transforms the input data to a feature space. The feature space is usually a higher dimensional space than the space of the original input data. The transformation is performed using a function from a family of functions often referred to in the literature as “kernel” functions. Many kernel functions exist and kernel functions may be created, usually through a combination of other kernel functions, according to a specific use-case. The choice of kernel function for a support vector machine regressor is a hyperparameter of the support vector machine model. Kernel functions possess certain mathematical properties. While a complete description of kernel functions and their associated properties exceeds the scope of this disclosure, it is stated that an important property of kernel functions is that they are amenable to the so-called “kernel trick.” The kernel trick allows for distances to be computed between pairs of data points in the feature space without actually transforming the data points from the original input space to the feature space. The second part of a support vector machine consists of parameterizing a hyperplane in the feature space. The hyperplane is described by a set of weights, {w₀, w₁, . . . , wₙ}. The hyperplane represents the predicted value of the support vector machine regressor given an input and can be written as

$$y = {w}_{0} + {\sum }_{i = 1}^{n} {w}_{i} {x}_{i} , \qquad ( 3 )$$

where y is the value of the hyperplane and xᵢ is a value on an axis i of the feature space where the feature space has n dimensions. Note that in some implementations a support vector machine regressor and associated kernel, the weight w₀ may be included in the summation. The set of weights may be described using a vector w. Likewise, a data point in the feature space may be described as a vector x. Incorporating w₀ into the weight vector and using vector notation, the prediction for a data point indexed by j may be written as

$${y}_{j} = {w}^{T} {x}_{j} . \qquad ( 4 )$$

To determine the values of the weights for a support vector machine regressor, also known as training the support vector machine model, the following optimization problem is solved:

$$min \frac{1}{2} {‖ w ‖}^{2} \qquad ( 5 )$$

$$subject to : \vert {y}_{j} - {w}^{T} {x}_{j} \vert \leq ϵ , ∀ j in training data ,$$

where ϵ is an error term, set by the user and may be considered another hyperparameter of the support vector machine model. From EQ. 4, it is seen that w^{T}xⱼ represents the predicted value, or in the context of the present disclosure, the predicted gas flow rate, for a training data point xⱼ. As such, the constraint |yⱼ−w^{T}xⱼ|≤ϵ in EQ. 5 indicates that the difference between the actual value yⱼ and the predicted value w^{T}xⱼ must be smaller than some pre-defined error ϵ. While this is an acceptable practice, it is noted that the hyperplane determined by EQ. 5 is quite sensitive to outlier data values. This is because the entirety of the hyperplane may need to be altered, often adversely, in order to accommodate the constraint of EQ. 5 for an outlier data point, or the value of E may have to be increased. To mitigate the negative effects of outliers in the data, and more generally to produce a support vector machine regressor with greater predictive power, EQ. 5 is altered to included slack terms (i and a regularization term A as follows:

$$min ( \frac{1}{2} {‖ w ‖}^{2} + λ {\sum }_{j = 1}^{m} \vert {ξ}_{j} \vert ) \qquad ( 6 )$$

$$subject to : \vert {y}_{j} - {w}^{T} {x}_{j} \vert \leq ϵ + \vert {ξ}_{j} \vert , ∀ j .$$

In EQ. 6, there are m data points in the training set and the data points are indexed by j. For each training data point there is a slack term (j which can alleviate the constraint. As such, the constraint may be satisfied, for example, for outlier data points, without altering the hyperplane. If the slack terms were allowed to grow without limitation, the slack terms would obviate the constraint. To counter this, the slack terms are preferred to be kept at minimal values as demonstrated by the second term to be minimized,

$${\sum }_{j = 1}^{m} \vert {ξ}_{j} \vert .$$

The inclusion of the second term in the minimization operator introduces a tradeoff between adjusting the hyperplane and limiting the slack terms. This tradeoff is controlled by the regularization term λ, which may be considered a hyperparameter of the support vector machine model.

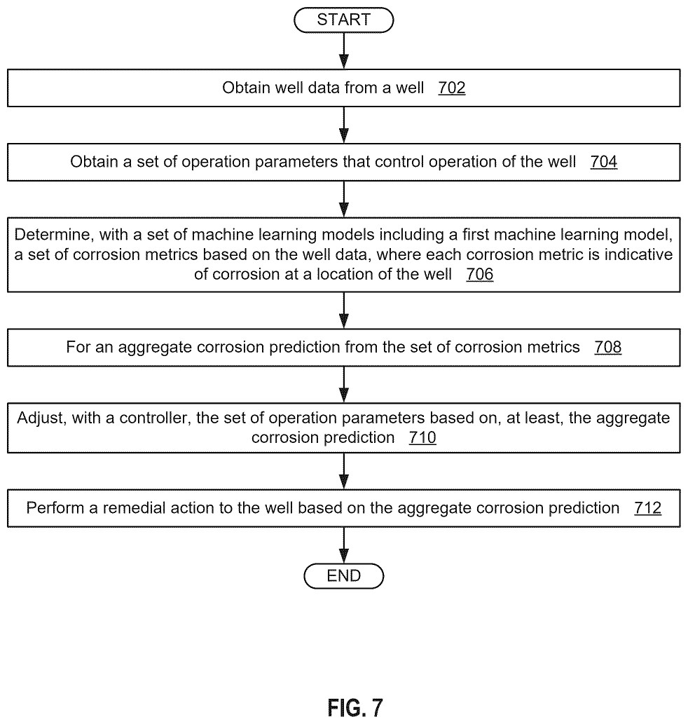

The process of evaluating well data and determining an aggregate corrosion prediction using the set of machine learning (ML) models is summarized in the flowchart of FIG. 7. In Block 702, well data is obtained from a well. Well data can include quantities such as one or more of: well age; corrosion logs; salinity measurements; pipe thickness data; pipe material data; scale thickness data; concentration data including the concentrations of corrosive molecule such as H2S, CO2, and ammonia; cement bond logs; downhole temperature data; downhole pressure data; data relating to the source and depth of corrosive substances (e.g., H2S); and derived quantities. In accordance with one or more embodiments, the well data describes characteristics of, at least, a pipe associated with the well, operating conditions and/or environment of the well (e.g., downhole temperature), and a fluid produced by the well. In Block 704, a set of operation parameters related to the well is obtained. In one or more embodiments, the set of operation parameters includes a choke setting for the well. In general, the set of operation parameters govern the behavior of the well and, in turn, govern a flow of the production fluid (e.g., adjustment of the operation parameters can directly influence the flow of the production fluid including its rate and composition).

In Block 706, a set of machine learning (ML) models, including at least a first machine learning model, is used to determine an associated set of corrosion metrics, each corrosion metric indicative of corrosion (e.g., metal loss) at a location of the well based on the well data. In one or more embodiments, the set of ML models further includes a second and a third machine learning model. In one or more embodiments, the first machine learned model is neural network, the second machine learning model is a random forest and the third machine learning model is a support vector machine. In Block 708, an aggregate corrosion prediction is formed from the set of corrosion metrics. In one or more embodiments, the aggregate corrosion prediction is determined by applying an aggregation function to the set of corrosion metrics. In one or more embodiments, the aggregation function is an average. In other embodiments, the aggregation function is a selection function that selects a single corrosion metric to act as the aggregate corrosion prediction, where the selection is made, for example, based on a confidence of each corrosion metric in the set of corrosion metrics.

In Block 710, the set of operation parameters are adjusted based on the aggregate corrosion prediction. In one or more embodiments, adjustment of the set of operation parameters is made using a controller. In one or more embodiments, the set of operation parameters are adjusted to a set of optimal operation parameters, where the optimization of the operation parameters is performed through evaluation of a performance metric based on, at least, the aggregate corrosion metric. In one or more embodiments, the performance metric is quantified by a quantity (or rate) of hydrocarbon production. That is, in these embodiments, the set of optimal operation parameters maximize hydrocarbon production from the well.

In Block 712, a remedial action is performed on the well based on the aggregate corrosion prediction. For example, dependent on the severity and associated location of the predicted corrosion, remedials actions may include, but are not limited to: using a casing patch to reline casing or tubing; squeeze cementing; use of pack-off to partially or completely block the circulation of fluid near the affected area; a workover procedure that may include the removal and replacement of production tubing and casing(s). In one or more embodiments, a remedial action may be determined based on the aggregate corrosion prediction. That is, the severity (e.g., magnitude of metal loss) and associated location of the aggregate corrosion can correspond with a remedial action. In one or more embodiments, the severity of the aggregate corrosion prediction is determined by comparing a value of the aggregate corrosion prediction to a predefined threshold. For example, in one or more embodiments, a remedial action is determined in response to the corrosion prediction exceeding the threshold.

Further, in some embodiments, the determined remedial action may be implemented or executed using, at least in part, the command system as directed by the corrosion prediction system. That is, one or more steps of a remedial action, such as limiting flow of fluids in a specified pipe, can be implemented automatically using the command system controlling the well.

Embodiments of the present disclosure may provide at least one of the following advantages. The corrosion prediction system described herein uses ML models such a neural network, random forest, and support vector machine to predict downhole casing corrosion which is one of the most important well integrity indicators. The use of the corrosion prediction system can be done in place of corrosion logs acquired using conventional methods, or at least allow for corrosion measurements to be acquired with a reduced frequency. Additionally, with continuous well data available the use of the corrosion prediction system allows for constant, real-time monitoring with a fast response. Critical conditions can be quickly determined. Additionally, an intervention service that is only capable of providing wireline or image logging inspection (ILI), for instance, can be dispatched with greater certainty of success with significant cost-saving benefits. Further, the network model results can determine the rate of corrosion of the whole network and give cautionary sign to the most corrosive spot/area of a well network. Validation tests using ILI and UT results have demonstrated that the corrosion prediction system is highly accurate and within 5% error. In contrast to the conventional corrosion monitoring devices, the corrosion prediction system disclosed herein approaches zero-intervention technique. Moreover, by continuously receiving and processing well data with the trained machine learned models disclosed herein, the well can be operated in an optimal state, greatly reducing the cost and time required to identify optimal settings. Further, the ML models can provide predictions in real time and can be periodically re-trained using production data. In other words, the ML models are always up-to-date. Additionally, embodiments disclosed herein describe methods to generate synthetic data to aid in training the ML models.

FIG. 8 further depicts a block diagram of a computer system (802) (e.g., the pressure control system) used to provide computational functionalities associated with the methods, functions, processes, flows, and procedures as described in this disclosure, according to one or more embodiments. The illustrated computer (802) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (802) may include a computer that includes an input device, such as a keypad, keyboard, touch screen, or other device that can accept user information, and an output device that conveys information associated with the operation of the computer (802), including digital data, visual, or audio information (or a combination of information), or a GUI.

The computer (802) can serve in a role as a client, network component, a server, a database or other persistency, or any other component (or a combination of roles) of a computer system for performing the subject matter described in the instant disclosure. In some implementations, one or more components of the computer (802) may be configured to operate within environments, including cloud-computing-based, local, global, or other environment (or a combination of environments).

At a high level, the computer (802) is an electronic computing device operable to receive, transmit, process, store, or manage data and information associated with the described subject matter. According to some implementations, the computer (802) may also include or be communicably coupled with an application server, e-mail server, web server, caching server, streaming data server, business intelligence (BI) server, or other server (or a combination of servers).

The computer (802) can receive requests over network (830) from a client application (for example, executing on another computer (802) and responding to the received requests by processing the said requests in an appropriate software application. In addition, requests may also be sent to the computer (802) from internal users (for example, from a command console or by other appropriate access method), external or third-parties, other automated applications, as well as any other appropriate entities, individuals, systems, or computers.

Each of the components of the computer (802) can communicate using a system bus (803). In some implementations, any or all of the components of the computer (802), both hardware or software (or a combination of hardware and software), may interface with each other or the interface (804) (or a combination of both) over the system bus (803) using an application programming interface (API) (812) or a service layer (813) (or a combination of the API (812) and service layer (813). The API (812) may include specifications for routines, data structures, and object classes. The API (812) may be either computer-language independent or dependent and refer to a complete interface, a single function, or even a set of APIs. The service layer (813) provides software services to the computer (802) or other components (whether or not illustrated) that are communicably coupled to the computer (802). The functionality of the computer (802) may be accessible for all service consumers using this service layer. Software services, such as those provided by the service layer (813), provide reusable, defined business functionalities through a defined interface. For example, the interface may be software written in JAVA, C++, or other suitable language providing data in extensible markup language (XML) format or another suitable format. While illustrated as an integrated component of the computer (802), alternative implementations may illustrate the API (812) or the service layer (813) as stand-alone components in relation to other components of the computer (802) or other components (whether or not illustrated) that are communicably coupled to the computer (802). Moreover, any or all parts of the API (812) or the service layer (813) may be implemented as child or sub-modules of another software module, enterprise application, or hardware module without departing from the scope of this disclosure.

The computer (802) includes an interface (804). Although illustrated as a single interface (804) in FIG. 8, two or more interfaces (804) may be used according to particular needs, desires, or particular implementations of the computer (802). The interface (804) is used by the computer (802) for communicating with other systems in a distributed environment that are connected to the network (830). Generally, the interface (804) includes logic encoded in software or hardware (or a combination of software and hardware) and operable to communicate with the network (830). More specifically, the interface (804) may include software supporting one or more communication protocols associated with communications such that the network (830) or interface's hardware is operable to communicate physical signals within and outside of the illustrated computer (802).

The computer (802) includes at least one computer processor (805). Although illustrated as a single computer processor (805) in FIG. 8, two or more processors may be used according to particular needs, desires, or particular implementations of the computer (802). Generally, the computer processor (805) executes instructions and manipulates data to perform the operations of the computer (802) and any algorithms, methods, functions, processes, flows, and procedures as described in the instant disclosure.

The computer (802) also includes a memory (806) that holds data for the computer (802) or other components (or a combination of both) that can be connected to the network (830). The memory may be a non-transitory computer readable medium. For example, memory (806) can be a database storing data consistent with this disclosure. Although illustrated as a single memory (806) in FIG. 8, two or more memories may be used according to particular needs, desires, or particular implementations of the computer (802) and the described functionality. While memory (806) is illustrated as an integral component of the computer (802), in alternative implementations, memory (806) can be external to the computer (802).

The application (807) is an algorithmic software engine providing functionality according to particular needs, desires, or particular implementations of the computer (802), particularly with respect to functionality described in this disclosure. For example, application (807) can serve as one or more components, modules, applications, etc. Further, although illustrated as a single application (807), the application (807) may be implemented as multiple applications (807) on the computer (802). In addition, although illustrated as integral to the computer (802), in alternative implementations, the application (807) can be external to the computer (802).

There may be any number of computers (802) associated with, or external to, a computer system containing computer (802), wherein each computer (802) communicates over network (830). Further, the term “client,” “user,” and other appropriate terminology may be used interchangeably as appropriate without departing from the scope of this disclosure. Moreover, this disclosure contemplates that many users may use one computer (802), or that one user may use multiple computers (802).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
obtaining well data from a well;
obtaining a set of operation parameters that control operation of the well;
determining, with a set of machine learning models comprising a first machine learning model, a set of corrosion metrics each indicative of corrosion at a location of the well based on the well data;
forming an aggregate corrosion prediction from the set of corrosion metrics; and
adjusting, with a controller, the set of operation parameters based on, at least, the aggregate corrosion prediction.

2. The method of claim 1,
wherein the set of operation parameters comprises a choke setting for a choke of the well.

3. The method of claim 1, further comprising:
determining a remedial action for the well in response to the aggregate corrosion prediction exceeding a threshold; and
executing the remedial action on the well.

4. The method of claim 1, wherein the well data comprises:
a downhole temperature of the well;
a concentration of hydrogen sulfide in a fluid produced by the well; and
an age of the well.

5. The method of claim 1, wherein:
the set of machine learning models further comprises a second machine learning model and a third machine learning model,
the first machine learned model is a neural network,
the second machine learning model is a random forest, and
the third machine learned model is a support vector machine.

6. The method of claim 1, further comprising:
determining, with an optimizer, a set of optimal operation parameters based on the aggregate corrosion prediction, wherein the set of optimal operation parameters maximize a production of hydrocarbons from the well.

7. The method of claim 1, further comprising:
obtaining historical data for the well comprising well data for the well;
determining a statistical descriptor from the historical data; and
generating synthetic data based on the statistical descriptor.

8. The method of claim 1, further comprising:
detecting, based on the aggregate corrosion prediction, an area of corrosion in the well.

9. A system, comprising:
a well;
a network model comprising a simulator and an optimizer; and
a controller that can configure one or more configurable parameters of the well, the one or more configurable parameters comprised by a set of operation parameters, the controller configured to:
obtain well data from the well;
determine, with a set of machine learning models comprising a first machine learning model, a set of corrosion metrics each indicative of corrosion at a location of the well based on the well data;
form an aggregate corrosion prediction from the set of corrosion metrics; and
adjust the set of operation parameters based on, at least, the aggregate corrosion prediction.

10. The system of claim 9,
wherein the set of operation parameters comprises a choke setting for a choke of the well.

11. The system of claim 9, wherein the controller is further configured to:
determine a remedial action for the well in response to the aggregate corrosion prediction exceeding a threshold; and
execute the remedial action on the well.

12. The system of claim 9, wherein the well data comprises:
a downhole temperature of the well;
a concentration of hydrogen sulfide in a fluid produced by the well; and
an age of the well.

13. The system of claim 9, wherein:
the set of machine learning models further comprises a second machine learning model and a third machine learning model,
the first machine learned model is a neural network,
the second machine learning model is a random forest, and
the third machine learned model is a support vector machine.

14. The system of claim 9, wherein the controller is further configured to:
determine, with the optimizer, a set of optimal operation parameters based on the aggregate corrosion prediction, wherein the set of optimal operation parameters maximize a production of hydrocarbons from the well.

15. The system of claim 9, wherein the controller is further configured to:
obtain historical data for the well comprising well data for the well;
determine a statistical descriptor from the historical data; and
generate synthetic data based on the statistical descriptor.

16. The system of claim 9, wherein the controller is further configured to:
detect, based on the aggregate corrosion prediction, an area of corrosion in the well.

17. The system of claim 9, wherein the controller is further configured to:
determine, using the simulator and based on the aggregate corrosion prediction, a region of corrosion in a pipe comprised by a well network that comprises the well.

18. A non-transitory computer-readable memory comprising computer-executable instructions stored thereon that, when executed on a processor, cause the processor to perform steps comprising:
obtaining well data from a well;
obtaining a set of operation parameters that control operation of the well;
determining, with a set of machine learning models comprising a first machine learning model, a set of corrosion metrics each indicative of corrosion at a location of the well based on the well data;
forming an aggregate corrosion prediction from the set of corrosion metrics; and
adjusting, with a controller, the set of operation parameters based on, at least, the aggregate corrosion prediction.

19. The non-transitory computer-readable memory of claim 18, the steps further comprising:
determining, with an optimizer, a set of optimal operation parameters based on the aggregate corrosion prediction, wherein the set of optimal operation parameters maximize a production of hydrocarbons from the well.

20. The non-transitory computer-readable memory of claim 18, the steps further comprising:
detecting, based on the aggregate corrosion prediction, an area of corrosion in the well.
